(19) United States
(12) Patent Application Publication
(10) Pub. No.: US 2014/0049955 A1
(43) Pub. Date: Feb. 20, 2014

(54) LED ILLUMINATION DEVICE

(71) Applicants: LUNG-HSIN CHEN, Hukou (TW); WEN-LIANG TSENG, Hukou (TW)

(72) Inventors: LUNG-HSIN CHEN, Hukou (TW); WEN-LIANG TSENG, Hukou (TW)

(21) Appl. No.: 13/663,492

(22) Filed: Oct. 30, 2012

(30) Foreign Application Priority Data
Aug. 17, 2012 (CN) 2012102936695

(51) Int. Cl. F21V 21/00; F21V 9/16

(52) U.S. Cl. 362/231; 362/249.02

(57) ABSTRACT

An exemplary LED illumination device includes a lighting member and a supporting member. The lighting member includes a base plate allowing light passing therethrough and LEDs mounted on a top surface of the base plate. The supporting member includes a bottom wall allowing light passing therethrough and side walls extending upwardly from edges of the bottom wall. The side walls and the bottom plate cooperatively define a receiving chamber therebetween to receive the base plate therein. Light generated by the LEDs radiates upwardly, downwardly and laterally from the LED illumination device.

### BACKGROUND

1. Technical Field

The disclosure generally relates to illumination devices, and more particularly to a light emitting diode (LED) illumination device having a wider range of illumination.

2. Description of Related Art

LEDs have many beneficial characteristics, including low electrical power consumption, low heat generation, long lifetime, small volume, good impact resistance, fast response and excellent stability. These characteristics have enabled the LEDs to be widely used as a light source in electrical appliances and electronic devices.

A conventional LED illumination device includes an LED module and an opaque cover enclosed the LED module therein. An opening is defined in a front side of the cover to allow the light from LEDs of the LED module to radiate therethrough. When the LED illumination device is operated, light emitted from the LED module illuminates a predetermined object through the opening only. An illumination range of the illumination device is narrow and limited.

What is needed, therefore, is an improved LED illumination device which overcomes the above described shortcomings.

### BRIEF DESCRIPTION OF THE DRAWINGS

FIG. 1 is a cross-sectional view of an LED illumination device according to an exemplary embodiment of the present disclosure.

FIG. 2 is an exploded view of the LED illumination device of FIG. 1.

FIG. 3 is a top view of a lighting member of the LED illumination device of FIG. 2.

FIG. 4 is a top view of a supporting member of the LED illumination device of FIG. 2.

FIG. 5 is a cross-sectional view of the supporting member of FIG. 4, taken along line VI-VI thereof.

### DETAILED DESCRIPTION

An embodiment of an LED illumination device in accordance with the present disclosure will now be described in detail below and with reference to the drawings.

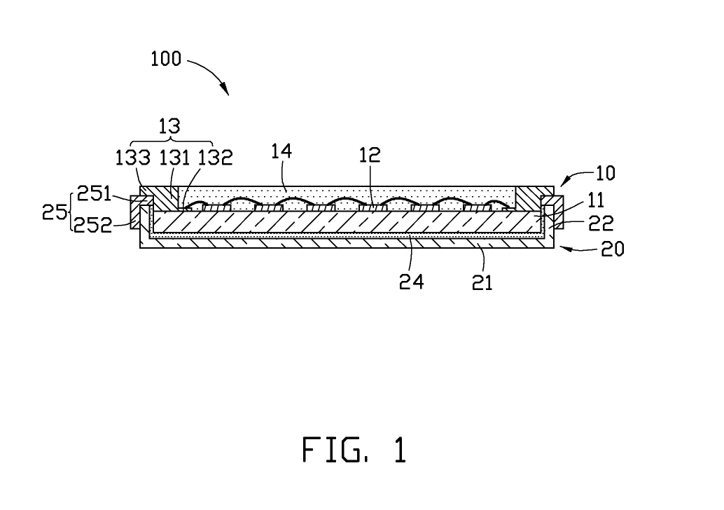

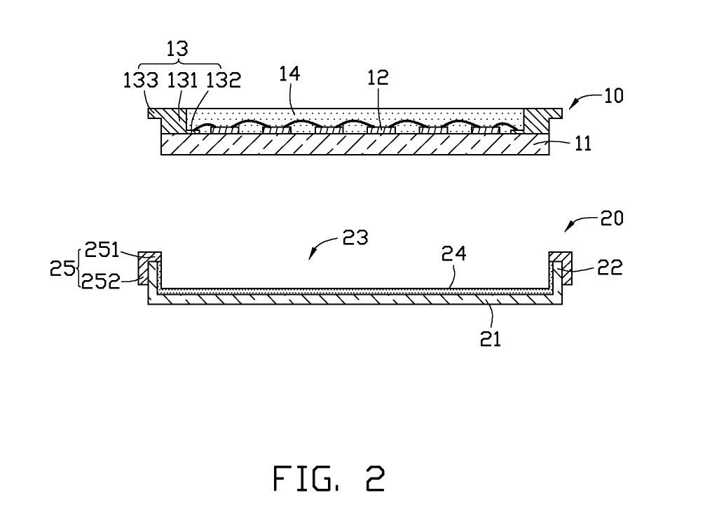

Referring to FIGS. 1-3, an LED illumination device 100 in accordance with an exemplary embodiment of the disclosure includes a lighting member 10 and a supporting member 20 supporting the lighting member 10.

The lighting member 10 includes a base plate 11, a plurality of LEDs 12 mounted on a top surface of the base plate 11, two first electrodes 13 arranged on opposite ends of the base plate 11, and a first phosphor layer 14 enclosing the LEDs 12 and mounted on the top surface of the base plate 11.

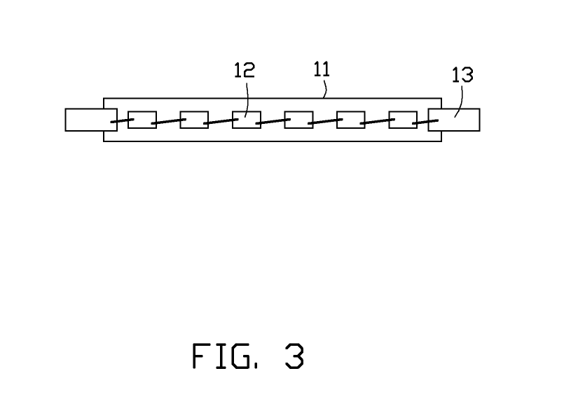

Referring also to FIG. 3, the base plate 11 is an elongated transparent plate or an elongated translucent plate and is made of glass, PMMA (polymethylmethacrylate) or PC (polycarbonate). The LEDs 12 are spaced from and aligned with each other along a longitudinal direction of the base plate 11. The LEDs 12 connect each other in series. Two of the LEDs 12 located at the opposite ends of the base plate 11 electronically connect with the first electrodes 13, respectively.

Each first electrode 13 includes a mounting portion 131, a first connecting portion 132 and a second connecting portion 133 extending from opposite lateral sides of the mounting portion 131. The mounting portion 131 is rectangular. A bottom surface of the mounting portion 131 is mounted on the top surface of the base plate 11. The first connecting portion 132 is rectangular and extends inwardly from a bottom end of an inner surface of the mounting portion 131. The second connecting portion 133 is rectangular and extends outwardly from a top end of an outer surface of the mounting portion 131. The first connecting portions 132 electronically connect the corresponding LEDs 12. The outer surfaces of the mounting portions 131 are coplanar with the opposite ends of the base plate 11. The inner surfaces of the mounting portions 131 face and are spaced from each other. The first electrodes 13 may be transparent.

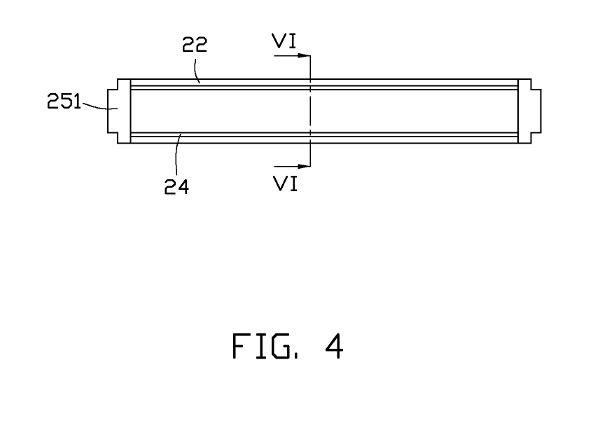

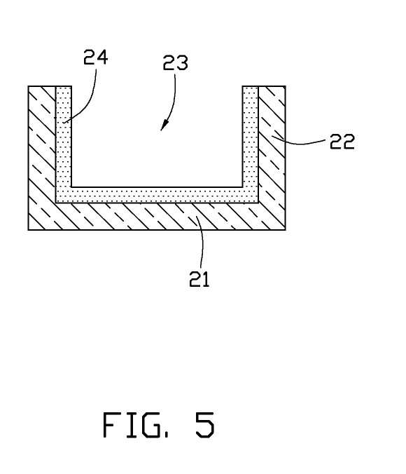

Referring also to FIGS. 4-5, the supporting member 20 is transparent or translucent, and includes an elongated bottom wall 21 and four side walls 22 extending upwardly from edges of the bottom wall 21. The side walls 22 perpendicularly connect with the bottom wall 21. The bottom wall 21 and the side walls 22 cooperatively define a receiving chamber 23 therebetween to receive the base plate 11 therein. A continuous second phosphor layer 24 entirely covers a top face of the supporting member 20 defining the receiving chamber 23. A thickness of the second phosphor layer 24 is uniform. The second phosphor layer 24 is thinner than the first phosphor layer 14.

Each of the first phosphor layer 14 and the second phosphor layer 24 is made of a mixture. The mixture includes a transparent base material and a plurality of phosphor powders evenly distributed in the transparent base material. The transparent base material is selected from silicone, epoxy, or silicone acrylate resin. A material of the phosphor powders is selected from yttrium aluminum garnet (YAG), terbium doped YGA and so on.

The supporting member 20 further includes two second electrodes 25 arranged on top ends of the two side walls 22 located at opposite ends of the bottom wall 21. Each second electrode 25 is L-shaped and includes a rectangular first engaging portion 251 and a rectangular second engaging portion 252 perpendicularly and downwardly extending from a lateral end of the engaging portion 251. The first engaging portion 251 is arranged on the top end of a corresponding side wall 22 to electronically connect with the second connecting portion 133 of a corresponding first electrode 13 of the lighting member 10. The second engaging portion 252 is arranged on an upper portion of an outer surface of the corresponding side wall 22 to electronically connect with an external power source (not shown). The second electrodes 25 may be transparent.

In assembly, the base plate 11 of the lighting member 10 is received in the receiving chamber 23 of the supporting member 20. An outer periphery of the lighting member 10 below the second connecting portions 133 directly contacts an inner surface of the second phosphor layer 24 and inner ends of the first engaging portions 251. Bottom surfaces of the second connecting portions 133 of the first electrodes 13 are adhered on top surfaces of the first engaging portions 251 of the second electrodes 25. In this state, the base plate 11 is parallel to the bottom wall 21.

When the LED illumination device 100 is operated, light emitted from the LEDs 12 radiates outwardly from top, bottom and lateral sides of the LED illumination device 100. Thus, the LED illumination device 100 has a radiation angle of 360 degrees. When the light travels through the first phosphor layer 14 and the second phosphor layer 24, the phosphor powders in the first phosphor layer 14 and the second phosphor layer 24 are stimulated to emit light with a predetermined color different from that from the LEDs. The light from the phosphor powders mixes with the light from the LEDs 12 to generate a light with the desired color. The powders in the first phosphor layer 14 can be the same as those in the second phosphor layer 24. Alternatively, the phosphor powders of the first phosphor layer 14 and the second phosphor layer 24 can be different and emit light of different colors when they are stimulated.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED illumination device comprising:
a lighting member comprising a base plate allowing light passing therethrough, two first electrodes arranged on opposite ends of the base plate, and a plurality of LEDs mounted on a top surface of the base plate and electronically connecting with the first electrodes; and
a supporting member supporting the lighting member, the supporting member allowing light passing therethrough, and having two second electrodes arranged on the supporting member and electronically connecting the first electrodes of the lighting member.

2. The LED illumination device of claim 1, wherein the supporting member comprises a bottom wall and a plurality of side walls extending upwardly from edges of the bottom wall, the bottom wall and the side walls cooperatively define a receiving chamber therebetween, and the base plate is received in the receiving chamber.

3. The LED illumination device of claim 2, wherein each second electrode comprises a first engaging portion and a second engaging portion bended from an end of the first engaging portion, and the first engaging portions of the two second electrodes are arranged on top ends of two of the side walls and respectively electronically connect the first electrodes, and each second engaging portion is located at an outer side of a corresponding side wall, configured for electronically connecting with an external power source.

4. The LED illumination device of claim 3, wherein each first electrode comprises a mounting portion mounted on the top surface of the base plate, a first connecting portion and a second connecting portion respectively extending inwardly and outwardly from opposite surfaces of the mounting portion, the first connecting portions of the first electrodes electronically connect with the LEDs located at the opposite ends of the base plate, and the second connecting portions of the first electrodes are mounted on top ends of the first engaging portions of the second electrodes.

5. The LED illumination device of claim 1, wherein the first electrodes and the second electrodes are transparent.

6. The LED illumination device of claim 2, wherein a first phosphor layer is mounted on the top surface of the base plate and encloses the LEDs therein.

7. The LED illumination device of claim 6, wherein a continuous second phosphor layer entirely covers a surface of the supporting member defining the receiving chamber.

8. The LED illumination device of claim 7, wherein each of the first phosphor layer and the second phosphor layer is made of a mixture consisting of a transparent base material and a plurality of phosphor powders distributed in the transparent base material.

9. The LED illumination device of claim 8, wherein the phosphor powders of the first phosphor layer and the second phosphor layer are different and emit different colored light when they are stimulate by light from the LEDs.

10. The LED illumination device of claim 1, wherein the base plate is elongated, and the LEDs are spaced from and aligned with each other along a longitudinal direction of the base plate.

11. The LED illumination device of claim 10, wherein the LEDs connect each other in series and two of the LEDs located at the opposite ends of the base plate electronically connect with the first electrodes.

12. An LED illumination device comprising:
a lighting member comprising a base plate allowing light passing therethrough and a plurality of LEDs mounted on a top surface of the base plate; and
a supporting member comprising a bottom wall allowing light passing therethrough and a plurality of side walls extending upwardly from edges of the bottom wall, the side walls and the bottom plate cooperatively defining a receiving chamber therebetween to receive the base plate therein, light generated by the LEDs radiating through the base plate and the bottom wall.

13. The LED illumination device of claim 12, wherein the base plate and the bottom wall are elongated, and the base plate is parallel to the bottom wall.

14. The LED illumination device of claim 12, wherein each side wall allows light passing therethrough, and the light generated by the LEDs also radiates through the sidewalls.

15. The LED illumination device of claim 12, wherein two first electrodes are arranged on opposite ends of the base plate and electronically connect with the LEDs, and two second electrodes are arranged on two of the side walls and electronically connect with the first electrodes.

16. The LED illumination device of claim 15, wherein the first electrodes and the second electrodes are transparent.

17. The LED illumination device of claim 12, wherein a first phosphor layer is mounted on the top surface of the base plate and encloses the LEDs therein.

18. The LED illumination device of claim 17, wherein a continuous second phosphor layer entirely covers a surface of the supporting member defining the receiving chamber.

19. The LED illumination device of claim 18, wherein an outer periphery of a bottom end of the lighting member directly contacts an inner surface of the second phosphor layer.

20. The LED illumination device of claim 19, wherein the second phosphor layer is thinner than the first phosphor layer.
